(19) United States
(12) Patent Application Publication
(10) Pub. No.: US 2025/0121453 A1
(43) Pub. Date: Apr. 17, 2025

(54) LASER PROCESSING DEVICE

(71) Applicant: MAKEBLOCK CO., LTD., Shenzhen (CN)

(72) Inventors: Wenhua WANG, Shenzhen (CN); Zhinuan DENG, Shenzhen (CN)

(73) Assignee: MAKEBLOCK CO., LTD., Shenzhen (CN)

(21) Appl. No.: 18/989,510

(22) Filed: Dec. 20, 2024

Related U.S. Application Data
(63) Continuation of application No. 18/875,655, filed on Jan. 1, 0001.
Application No. 18/875,655 is a continuation of application No. PCT/CN2023/139119, filed on Dec. 15, 2023.

(30) Foreign Application Priority Data
Nov. 9, 2022 (CN) 202222998352.3
May 17, 2023 (CN) 202321194516.5
Jul. 21, 2023 (CN) 202321963653.0
Aug. 30, 2023 (CN) 202322356646.0
Sep. 18, 2023 (CN) 202322547620.4
Oct. 10, 2023 (CN) 202322738162.2

(51) Int. Cl. B23K 26/06

(52) U.S. Cl. CPC B23K 26/06

(57) ABSTRACT

Disclosed in the present application is a laser processing device. The laser processing device includes a machine base, a laser processing head and an enclosure. The machine base is configured to bear a workpiece to be processed. The laser processing head is connected to the machine base and is configured to process the workpiece to be processed. The enclosure is slidingly connected to the machine base and is configured to filter the laser beam reflected when the laser processing head processes the workpiece to be processed. At the same time, the enclosure can also isolate smoke generated during laser processing, thereby preventing the processing environment from being polluted.

### CROSS-REFERENCE TO RELATED APPLICATIONS

This application is a continuation of application Ser. No. 18/875,655, filed on Dec. 16, 2024, which is the National Stage of International Application No. PCT/CN2023/139119, filed on Dec. 15, 2023, which claims priority to Chinese Patent Application No. 2023219636530, filed on Jul. 21, 2023, Chinese Patent Application No. 2023223566460, filed on Aug. 30, 2023, Chinese Patent Application No. 2023211945165, filed on May 17, 2023, Chinese Patent Application No. 2022229983523, filed on Nov. 9, 2022, Chinese Patent Application No. 2023225476204, filed on Sep. 18, 2023, and Chinese Patent Application No. 2023227381622, filed on Oct. 10, 2023. The entire contents of the above-mentioned applications are incorporated herein by reference.

### TECHNICAL FIELD

The present application relates to the technical field of laser processing, and in particular to a laser processing device.

### BACKGROUND

A laser processing device uses laser as the processing medium to process. Usually before processing, the user needs to place the consumables to be processed on the laser processing device, and then adjust the focus so that the focus of the emitted laser just acts on the surface of the consumables, so that the laser beam can cut or engrave the consumables.

### SUMMARY

The embodiment of the present application provides a laser processing device, including:
a machine base, configured to bear a workpiece to be processed;
a laser processing head connected to the machine base, wherein the laser processing head is configured to process the workpiece to be processed; and
an enclosure slidably connected to the machine base, wherein the enclosure is configured to filter a laser beam reflected when the laser processing head processes the workpiece to be processed.

### BRIEF DESCRIPTION OF THE DRAWINGS

FIG. 1 is a schematic diagram of an overall structure of a laser processing device according to the present application.

FIG. 2 is a schematic structural diagram of the laser processing device according to the present application, with an enclosure omitted.

FIG. 3 is a schematic structural diagram of the laser processing device according to the present application, with the enclosure connected to a supporting frame.

FIG. 4 is a schematic structural diagram of a limiting assembly of the laser processing device according to the present application.

FIG. 5 is a schematic structural diagram of the structure shown in FIG. 2 viewed in the direction of arrow A.

FIG. 6 is a schematic structural diagram of an internal structure of the supporting frame of the laser processing device according to the present application.

FIG. 7 is a schematic diagram of a connection between a driving assembly and a slider inside the supporting frame of the laser processing device according to the present application.

FIG. 8 is a schematic structural diagram of a laser processing head in the structure shown in FIG. 2, with a housing omitted.

FIG. 9 is a schematic diagram of the internal structure of the laser processing head of the laser processing device according to the present application.

FIG. 10 is a schematic diagram of the internal structure of the laser processing head of the laser processing device according to the present application.

FIG. 11 is a schematic diagram of the internal structure of the laser processing head of the laser processing device according to the present application.

FIG. 12 is a schematic diagram of the internal structure of the laser processing head of the laser processing device according to the present application.

FIG. 13 is a schematic diagram of the back of the laser processing device according to the present application.

FIG. 14 is a schematic diagram of the use of the laser processing device with a rotating accessory according to an embodiment.

FIG. 15 is a schematic diagram of the use of the laser processing device with a rotating accessory according to an embodiment.

FIG. 16 is a schematic diagram of the use of the laser processing device with the amplification accessory according to an embodiment.

### DETAILED DESCRIPTION OF THE EMBODIMENTS

The present application provides a laser processing device. In order to make the purpose, technical solution and effect of the present application clearer, the present application will be further described in detail below with reference to the accompanying drawings and embodiments. It should be understood that the specific embodiments described here are only used to explain the present application and are not used to limit the present application.

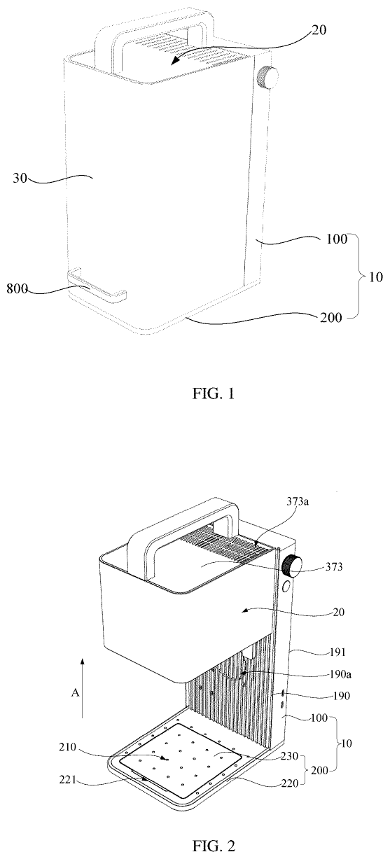

As shown in FIG. 1 and FIG. 2, the laser processing device according to an embodiment of the present application includes a machine base 10 for bearing a workpiece to be processed, a laser processing head 20 and an enclosure 30. The laser processing head 20 is connected to the machine base 10 and is configured to process the workpiece to be processed. The enclosure 30 is slidingly connected to the machine base 10 and is configured to filter the laser beam reflected when the laser processing head 20 processes the workpiece to be processed. The enclosure 30 can be a translucent filter cover, which can not only filter out laser light to protect the user's eyes, but also facilitate the user to observe the processing progress of the consumables on the machine base 10.

By providing the enclosure 30, during processing, the enclosure 30 can block the laser beam reflected when the laser processing head 20 processes the workpiece to be processed, so that the laser processing device has its own protection when used, and the user can be effectively prevented the laser from damaging the user's eyes without goggles, which greatly improves the convenience of using the laser processing device. At the same time, the enclosure 30 can also isolate smoke generated during laser processing to prevent the processing environment from being polluted.

In an embodiment of the present application, the enclosure 30 is slidingly connected to the machine base 10 and is movable relative to the laser processing head 20. It can be understood that when the enclosure 30 slides on the machine base 10, the laser processing head 20 can be in a stationary state. Alternatively, when the laser processing head 20 slides on the machine base 10, the enclosure 30 can be in a stationary state. Since the enclosure 30 and the laser processing head 20 are independent of each other, the sliding of the enclosure 30 is not restricted by the laser processing head 20. When the enclosure 30 slides to the highest point relative to the supporting frame 100, the processing space can be opened to the maximum extent for cleaning without disassembly. In addition, when the laser processing head 20 adjusts the focus to adapt to consumables of different thicknesses, the enclosure 30 does not block the laser processing head 20 from sliding up and down, so the sliding of the laser processing head 20 is not restricted by the enclosure 30.

As shown in FIG. 2, the machine base 10 includes the supporting frame 100 and a workbench 200 connected to the supporting frame 100. The workbench 200 is configured to bear the workpiece to be processed. The supporting frame 100 can be integrally formed with the workbench 200, or can also be fixedly connected to the workbench 200 through screws. The laser processing head 20 is connected to the supporting frame 100 and is opposite to the workbench 200. The enclosure 30 is slidingly connected to the supporting frame 100. When the enclosure 30 is abutted against the workbench 200, the laser processing head 20, the workbench 200, the supporting frame 100 and the enclosure 30 are enclosed to form a processing space. When the laser processing device performs a processing task, the bottom end of the enclosure 30 is abutted against the workbench 200 to close the processing space on the workbench 200, thereby protecting the user.

In an embodiment of the present application, along a direction perpendicular to sliding movement of the enclosure 30, a projection of the laser processing head 20 and the projection of the enclosure 30 at least partially coincide. When the processing space is closed, even if the laser processing head 20 rises to the highest point, since the laser processing head 20 and the enclosure 30 at least partially coincide, the processing space always remains closed, thereby avoiding laser overflow in the processing space. The enclosure 30 can better filter the laser beam reflected when the laser processing head 20 processes the workpiece to be processed, so as to better protect the user's eyes.

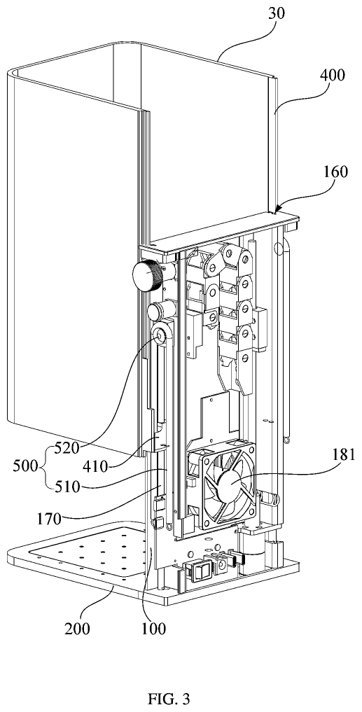

The enclosure 30 is slidingly connected to the supporting frame 100. As shown in FIG. 3, the enclosure 30 is provided with a connecting block 410, and the supporting frame 100 is provided with a sliding rod 170 inside. The connecting block 410 is provided with a sliding hole that is slidingly matched with the sliding rod 170. The connecting block 410 can slide up and down relative to the supporting frame 100 through the sliding rod 170 passing through the sliding hole. In this embodiment, the sliding of the enclosure 30 relative to the supporting frame 100 is realized through the cooperation of the connecting block 410 and the sliding rod 170. The structure is simple and the connection is reliable.

The supporting frame 100 is provided with a chute 160, and the enclosure 30 is provided with a sliding bar 400. The sliding bar 400 is slidingly provided in the chute 160. By providing the chute 160 and the sliding bar 400, the reliability and stability of sliding of the enclosure 30 relative to the supporting frame 100 can be ensured.

As shown in FIG. 1, the enclosure 30 can also be provided with a handle 800. The handle 800 is configured to provide a force application point to the user so that the user can lift the enclosure 30 to open the processing space. By providing the handle 800, the user can conveniently open the enclosure 30, and the sliding bars 400 on the enclosure 30 move along the chute 160 on the supporting frame 100, making the opening of the enclosure 30 smoother.

In an embodiment of the present application, in order to facilitate the use of the laser processing device, the laser processing device also includes a hover assembly 500. The hover assembly 500 is provided between the enclosure 30 and the supporting frame 100. The hover assembly 500 is configured to keep the enclosure 30 in a hovering state to open the processing space. Therefore, when the laser processing device completes the processing task, the user only needs to lift the enclosure 30, and the enclosure 30 will automatically remain in the hovering state to facilitate the user to remove the processed consumables from the workbench 200, thereby making the use of the laser processing device convenient and reliable, which is conducive to improving user convenience.

Referring to FIG. 3, the hovering assembly 500 includes an elastic member 510. One end of the elastic member 510 is connected to the supporting frame 100, and the other end of the elastic member 510 is connected to the enclosure 30. The elastic member 510 allows the enclosure 30 to tend to move in a direction away from the workbench 200. Specifically, when the laser processing device completes the processing task, the user only needs to lift the enclosure 30. At this time, the elastic member 510 can provide the enclosure 30 with an elastic restoring force to move the enclosure 30 in the direction away from the workbench 200. When the elastic restoring force is balanced with the gravity of the enclosure 30, the enclosure 30 will be in a hovering state relative to the workbench 200, so that the processing space remains open and the user can easily take out consumables. Through the hovering assembly 500 in this embodiment, the enclosure 30 can automatically be in a hovering state with the processing space opened. The user does not need to hold the enclosure 30 with his hands when taking away consumables from the workbench 200 or places consumables on the workbench 200, which greatly improves the convenience of using the machine.

The elastic member 510 can be a tension spring, a compression spring, an elastic cord, or the like. In an embodiment, the hovering assembly 500 further includes a winding post 520. The winding post 520 is provided on an end of the supporting frame 100 away from the workbench 200. The elastic member 510 is wound around the winding post 520. Specifically, one end of the elastic member 510 connected to the supporting frame 100 is provided close to the workbench 200, and one end of the elastic member 510 connected to the enclosure 30 goes around the winding post 520 and is connected to the enclosure 30. By providing the winding post 520, the arrangement of the elastic member 510 (such as a tension spring) can be facilitated, and the elastic restoring force exerted by the elastic member 510 on the enclosure 30 can be increased to a certain extent, which is beneficial for the enclosure 30 to be reliably and stably maintained in the hovering state.

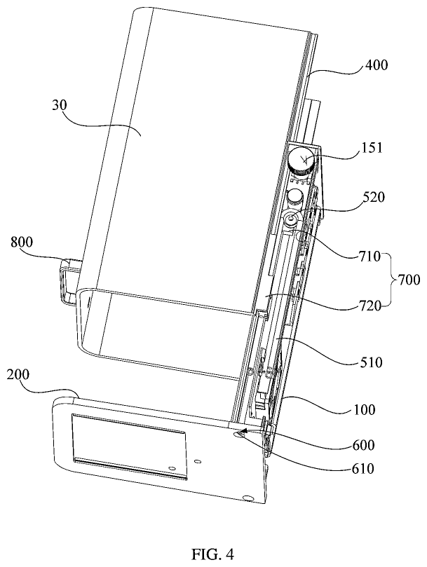

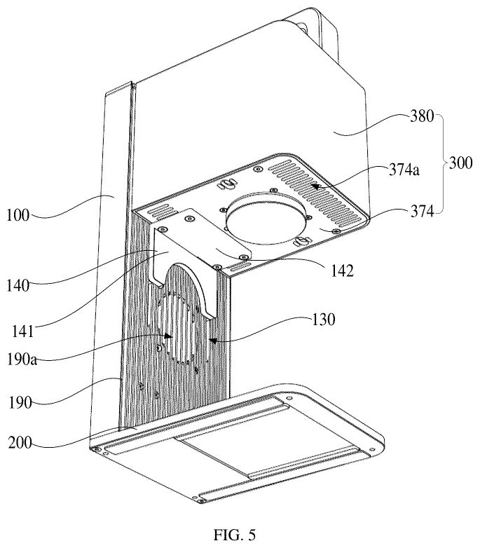

In an embodiment of the present application, the laser processing device further includes a locking assembly 600. The locking assembly 600 is provided between the workbench 200 and the enclosure 30, or between the supporting frame 100 and the enclosure 30. The locking assembly 600 is configured to abut the enclosure 30 against the workbench 200 to close the processing space. As shown in FIG. 4, the locking assembly 600 includes a first magnetic block 610 and a second magnetic block (not shown). The first magnetic block 610 and the second magnetic block can attract each other. The first magnetic block 610 is provided on the workbench 200 or the supporting frame 100, the second magnetic block is provided on the enclosure 30 and faces the first magnetic block 610. The adsorption force generated by the first magnetic block 610 and the second magnetic block is used to make the enclosure 30 be abutted against the workbench 200.

Specifically, when the enclosure 30 is abutted against the workbench 200 to close the processing space, an adsorption force is generated between the first magnetic block 610 and the second magnetic block, and the adsorption force is greater than the elastic restoring force of the elastic member 510 so that the elastic member 510 remains in a stretched state. When the processing space needs to be opened, the user lifts the enclosure 30 through the handle 800 to separate the first magnetic block 610 from the second magnetic block. When a distance between the first magnetic block 610 and the second magnetic block is greater than a preset value, no adsorption force can be generated between the two. At this time, the user removes the force on the handle 800. Due to the elastic restoring force of the elastic member 510 on the enclosure 30, that is, the elastic restoring force exerted by the elastic member 510 on the enclosure 30 is balanced with the gravity of the enclosure 30 itself, so that the enclosure 30 is in the hovering state and the processing space is kept in an open state.

In order to prevent the enclosure 30 from being separated from the machine base 10 during the lifting process, the laser processing device also includes a limiting assembly 700. The limiting assembly 700 is provided between the supporting frame 100 and the enclosure 30. The limiting assembly 700 is configured to limit the sliding displacement range of the enclosure 30 relative to the supporting frame 100. As shown in FIG. 4, the limiting assembly 700 includes a first limiting block 710 and a second limiting block 720. The first limiting block 710 is provided on the supporting frame 100, and the second limiting block 720 is provided on the enclosure 30. The first limiting block 710 is used to be abutted against the second limiting block 720 to limit the sliding displacement range of the enclosure 30 relative to the supporting frame 100. Specifically, when the enclosure 30 is in the aforementioned hovering state, the first limiting block 710 and the second limiting block 720 just abut against each other. By providing the first limiting block 710 and the second limiting block 720, when the processing space needs to be opened, the enclosure 30 is raised to a certain height until the first limiting block 710 and the second limiting block 720 abut against each other. At this time, the enclosure 30 cannot continue to be lifted upward, thereby effectively preventing the enclosure 30 from being separated from the machine base 10, which greatly improves the reliability of the laser processing device.

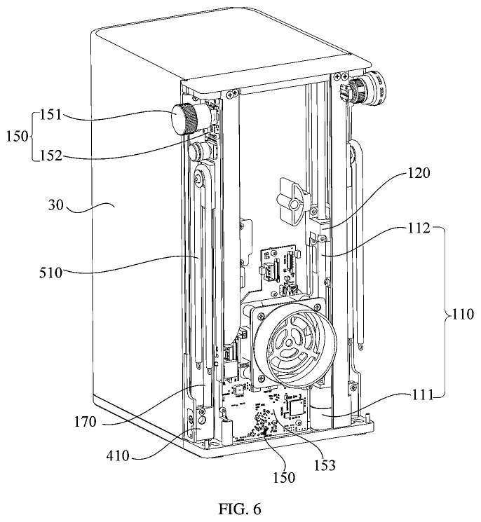

As shown in FIG. 5 and FIG. 6, in an embodiment of the present application, the laser processing head 20 is slidingly connected to the supporting frame 100. By providing the laser processing head 20 to be slidable relative to the supporting frame 100, it is convenient to move the laser processing head 20 up and down according to actual needs to adjust focus to adapt to consumables of different thicknesses.

A driving assembly 110 connected to the laser processing head 20 is provided inside the supporting frame 100. The driving assembly 110 drives the laser processing head 20 to slide relative to the supporting frame 100. In an embodiment, the supporting frame 100 includes a slider 120, a connecting groove 130, and a fixed plate 140. The connecting groove 130 is a strip-shaped through groove provided on the surface of the supporting frame 100. The slider 120 is provided inside the supporting frame 100. One end of the slider 120 is connected to the driving assembly 110 and the other end passes through the connecting groove 130 and is connected to the fixed plate 140. The fixed plate 140 is also connected to the laser processing head 20. Specifically, the fixed plate 140 includes a first fixed plate 141 and a second fixed plate 142 connected to the first fixed plate 141. The first fixed plate 141 is fixedly connected to the slider 120, and the second fixed plate 142 is relatively fixedly connected to the laser processing head 20.

As shown in FIG. 6, the driving assembly 110 includes a driving piece 111 and a screw rod 112. The driving piece 111 and the screw rod 112 are provided inside the supporting frame 100. The length direction of the screw rod 112 is parallel to the length direction of the connecting groove 130. The slider 120 is sleeved outside the screw rod 112 and is threaded with the screw rod 112. One end of the screw rod 112 is connected to the driving shaft of the driving piece 111. The driving piece 111 can be a motor, and the motor drives the screw rod 112 to rotate so that the slider 120 moves up and down along the length direction of the screw rod 112. In this embodiment, the driving piece 111 is connected to the slider 120 through a transmission mechanism such as the screw rod 112 to drive the slider 120 to move, thereby driving the fixed plate 140 and the laser processing head 20 connected to the fixed plate 140 to move in the extension direction of the connecting groove 130.

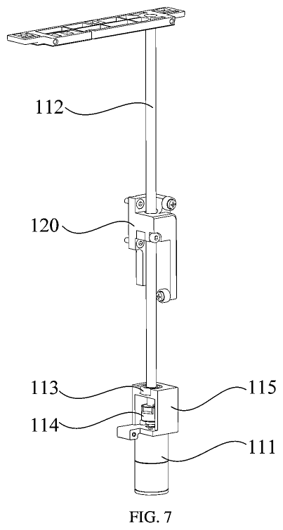

As shown in FIG. 7, in an embodiment, a bearing 113 is provided outside the screw rod 112. The bearing 113 is configured to support the rotation of the screw rod 112, reduce the friction coefficient generated during the rotation of the screw rod 112, and ensure the rotation accuracy of the screw rod 112. Specifically, a coupling 114 is provided between the driving piece 111 and the screw rod 112. One end of the coupling 114 is connected to the driving shaft of the driving piece 111, and the other end is connected to the screw rod 112, for stably connecting the driving piece 111 and the screw rod 112. The driving piece 111 can stably drive the screw rod 112 to rotate.

It can be understood that the coupling 114 is a rigid coupling. The rigid coupling has high precision and can maintain accurate alignment between the driving piece 111 and the screw rod 112. Alternatively, the coupling 114 is a movable coupling. During the actual application process of the rigid coupling, due to manufacturing and installation errors and other factors, when the motor rotates, the rigid coupling may produce slight deviations and misalignment, thereby causing an increase in the load of the driving piece 111. In order to reduce the impact of the coupling 114 on the load of the driving piece 111, the coupling 114 can use a movable coupling. The movable coupling has a certain elastic deformation ability and can adjust the misalignment and deviation between the driving piece 111 and the screw rod 112 to a certain extent to maintain the smoothness of transmission, thereby reducing the additional load on the driving piece 111.

In an embodiment, the driving piece 111 is further provided with a fixed frame 115. One end of the fixed frame 115 is fixedly connected to the housing 300 of the driving piece 111, and the other end forms a receiving part for accommodating the bearing 113. The bearing 113 is accommodated in the receiving part, and the receiving part is configured to fix the outer ring portion of the bearing 113 so that the inner ring portion of the bearing 113 can rotate with the rotation of the screw rod 112, thereby reducing the friction coefficient of the screw rod 112.

In an embodiment of the present application, as shown in FIG. 6, the laser processing device also includes a control assembly 150. Specifically, the control assembly 150 includes a knob 151, and the knob 151 is drivingly connected to the screw rod 112. By rotating the knob 151 in different directions to act on the screw rod 112, the screw rod 112 drives the laser processing head 20 to rise or fall to adjust the focus, which facilitates the user's operation.

In another embodiment of the present application, the control assembly 150 is electrically connected to the driving assembly 110, and is configured to send an electrical signal to the driving assembly 110, so that the driving assembly 110 drives the laser processing head 20 to move according to the user's expectations. Specifically, as shown in FIG. 6, the control assembly 150 includes a knob 151, a first circuit board 152 and a second circuit board 153 provided on the machine base 10. The knob 151 is electrically connected to the first circuit board 152, the first circuit board 152 and the second circuit board 153 are electrically connected through wires, and the second circuit board 153 is electrically connected to the driving assembly 110. It can be understood that the second circuit board 153 is electrically connected to the driving piece 111.

It can be understood that rotating the knob 151 in different directions can trigger the first circuit board 152 to send different driving electrical signals. The driving electrical signals are sent to the driving assembly 111 through the second circuit board 153. The driving assembly 111 drives the laser processing head 20 to move in the corresponding direction after receiving the electrical signals. The knob 151 rotates clockwise to trigger the first circuit board 152 to send a first level signal. The first circuit board 152 sends the first circuit signal to the driving assembly 111 through the second circuit board 153. After receiving the first level signal, the driving assembly 111 drives the laser processing head 20 to rise. Alternatively, the knob 151 rotates counterclockwise to trigger the first circuit board 152 to send a second level signal. The first circuit board 152 sends the second level signal to the driving assembly 111 via the second circuit board 153. After receiving the second level signal, the driving assembly 111 drives the laser processing head 20 to descend.

It can be understood that the first level signal and the second level signal are different electrical signals. For example, the first level signal is a high level signal, the second level signal is a low level signal, or the first level signal and the second level signal are a combined electrical signal of high and low level signals. By rotating the knob 151 in different directions to send different level signals to act on the driving piece 111, the driving piece 111 can drive the screw rod 112 to drive the laser processing head 20 up or down to adjust the focus, so that the height of the laser processing head 20 can be accurately controlled and adjusted, which facilitates user's operation.

It can be understood that the knob 151 can be a columnar fixed knob with anti-slip stripes on its side. When the user grasps the knob 151 to rotate the knob 151, the friction force between the user's hand and the knob 151 is increased, so that the user can twist the knob 151 better.

Alternatively, the knob 151 can be a spring return knob. The spring return knob includes a handle and a built-in spring structure. The handle can allow the user to rotate and operate the knob 151 more conveniently. When the handle is released after rotation, the handle will automatically return to its original position under the action of its built-in spring structure, making it convenient for the user to quickly adjust the knob 151.

In another embodiment of the present application, the enclosure 30 can also be connected to the laser processing head 20, that is, the enclosure 30 can be connected to the housing 300 of the laser processing head 20. When the laser processing head 20 moves up and down, the enclosure 30 can be driven to move up and down together. In detail, the laser processing head 20 is connected to a driving piece (such as the aforementioned driving piece 111) provided in the machine base 10, and the driving piece can be a motor. The laser processing head 20 is driven by a motor to move up and down along the supporting frame 100. In an embodiment, the enclosure 30 is detachably connected to the laser processing head 20 to facilitate cleaning of the interior of the processing space.

The laser processing head 20 in the embodiment of the present application is a component configured to introduce a laser beam into the processing space.

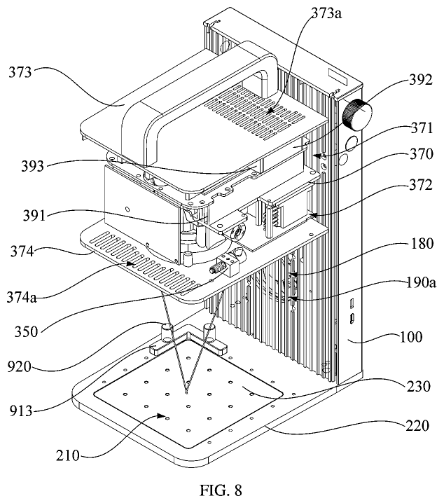

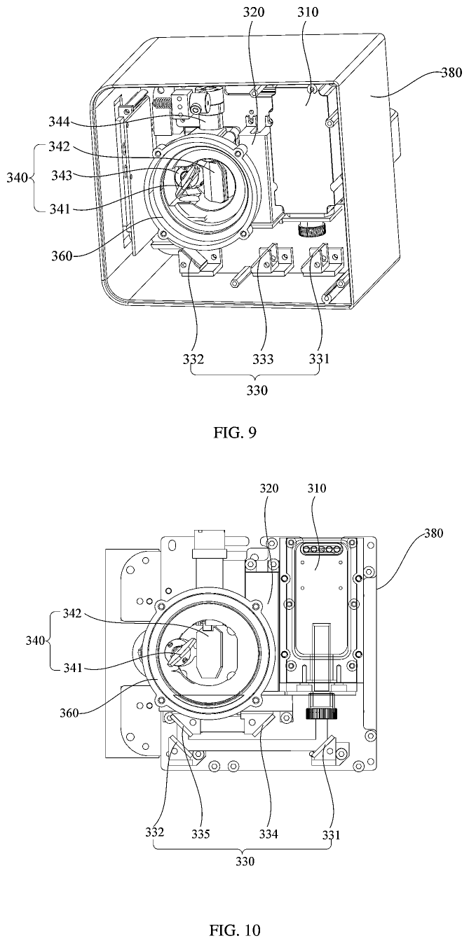

Referring to FIG. 8 and FIG. 9, in an embodiment of the present application, the laser processing head 20 includes a first laser emitter 310 and a second laser emitter 320, as well as a reflector assembly 330 and a galvanometer assembly 340. The first laser emitter 310 is configured to emit a first laser beam, and the second laser emitter 320 is configured to emit a second laser beam. The reflector assembly 330 is provided corresponding to the first laser emitter 310 and the second laser emitter 320, for receiving and reflecting the first laser beam and/or the second laser beam. The galvanometer assembly 340 is provided correspondingly to the reflector assembly 330, for receiving the first laser beam and/or the second laser beam reflected by the reflector assembly 330, and for reflecting it onto the workpiece to process the workpiece.

In the embodiment of the present application, since the laser processing head 20 includes the first laser emitter 310 and the second laser emitter 320, by setting the type and/or power of the laser beam emitted by the first laser emitter 310 and the second laser emitter 320, the laser processing head 20 can emit different types of laser beams and/or emit laser beams of different powers, which can better meet the user's needs for processing more workpieces of different materials and processing beams of different powers. In addition, since the laser beams emitted by each laser emitter in the embodiment of the present application are not directly emitted to the galvanometer assembly 340, but are emitted to the galvanometer assembly 340 through the reflector assembly 330. Due to the existence of the reflector assembly 330, when at least two laser emitters are provided in the laser processing head 20, the laser emitters can be arranged more freely and are not limited by the position of the galvanometer assembly 340.

In an embodiment, as shown in FIG. 9, the reflector assembly 330 includes a first reflector 331 and a second reflector 332. The first reflector 331 is provided corresponding to the first laser emitter 310 and is configured to reflect the first laser beam to the second reflector 332. The second reflecting reflector 332 is provided between the first reflector 331 and the galvanometer assembly 340, and is configured to reflect the first laser beam reflected by the first reflector 331 to the galvanometer assembly 340.

In an embodiment of the present application, as shown in FIG. 9, the reflector assembly 330 also includes a first beam combiner 333. The first beam combiner 333 is provided corresponding to the second laser emitter 320 and is located between the first reflector 331 and the second reflector 332. The first beam combiner 333 is configured to reflect the second laser beam to the second reflector 332, and the second reflector 332 reflects the second laser beam to the galvanometer assembly 340. The first beam combiner 333 can also be configured to transmit the first laser beam reflected by the first reflector 331 to the second reflector 332.

In this embodiment, the first reflector 331, the second reflector 332 and the first beam combiner 333 are on the same straight line. Since the first laser emitter 310 and the second laser emitter 320 share the second reflector 332, that is, the laser beams emitted by both are reflected to the galvanometer assembly 340 through the second reflector 332, and the first beam combiner 333 can reflect the first laser beam and transmit the second laser beam, the number of lenses can be reduced, and the space required for the reflector assembly 330 can be saved, making the internal structure of the laser processing head 20 more compact.

In an embodiment of the present application, as shown in FIG. 10, the reflector assembly 330 includes a first reflector 331, a second reflector 332, a third reflector 334 and a second beam combiner 335. The first reflector 331 is provided corresponding to the first laser emitter 310 and is configured to reflect the first laser beam to the second reflector 332. The second reflector 332 is provided between the first reflector 331 and the second beam combiner 335, and is configured to reflect the first laser beam to the second beam combiner 335. The third reflector 334 is provided corresponding to the second laser emitter 320, and is configured to reflect the second laser beam to the second beam combiner 335. The second beam combiner 335 is provided corresponding to the third reflector 334 and is located between the second reflector 332 and the galvanometer assembly 340. The second beam combiner 335 is configured to reflect the second laser beam to the galvanometer assembly 340, and is also configured to transmit the first laser beam reflected by the second reflector 332 to the galvanometer assembly 340.

In this embodiment, since the first laser beam emitted by the first laser emitter 310 is reflected to the galvanometer assembly 340 through the first reflector 331 and the second reflector 332, while the second laser beam emitted by the second laser emitter 320 is reflected to the galvanometer assembly 340 through the third reflector 334 and the second beam combiner 335. Therefore, when adjusting the angle of the beam reflected from each laser emitter to the galvanometer assembly 340, the angle of the beam of the first laser emitter 310 can be adjusted by adjusting the angle of the second reflector 332, and the angle of the beam of the second laser emitter 320 can also be adjusted by adjusting the angle of the second beam combiner 335. That is, the first laser emitter 310 and the second laser emitter 320 do not share a reflector. Their optical paths are independent and do not interfere with each other. The light emission angles of the two laser emitters at the galvanometer assembly 340 can be better adjusted.

It should be noted that the first laser emitter 310 and the second laser emitter 320 can emit different types of laser beams, that is, the type of the first laser beam and the second laser beam are different types of laser beams. For example, the first laser beam is blue light and the second laser beam is red light. Since different types of laser beams are suitable for processing different types of consumables, the user can select the corresponding laser beam according to the type of consumables. Alternatively, the first laser emitter 310 and the second laser emitter 320 can emit the same type of laser, at this time, the power of the first laser beam and the second laser beam may be the same or different. The user can select laser beams with different processing powers to process the workpiece by respectively activating the first laser emitter 310 or the second laser emitter 320, or the user can activate the first laser emitter 310 and the second laser emitter 320 at the same time, the superposition of laser beams emitted by two laser emitters can produce a higher power laser, thereby meeting the user's higher power laser needs.

In an embodiment of the present application, as shown in FIG. 9, the galvanometer assembly 340 includes a first galvanometer 341 and a second galvanometer 342. The first galvanometer 341 can rotate about the first axis, and the second galvanometer 342 can rotate around the second axis. The first axis and the second axis are perpendicular. By designing the first galvanometer 341 and the second galvanometer 342 into structures with adjustable angles, different positions of the consumables can be processed. Specifically, by adjusting the angles of the first galvanometer 341 and the second galvanometer 342, the direction of the laser beam can be adjusted in the vertical and horizontal directions, so that the laser beam acts on different positions of the consumable.

The first galvanometer 341 is provided corresponding to the reflector assembly 330. The first galvanometer 341 is configured to reflect the first laser beam and/or the second laser beam received from the reflector assembly 330 to the second galvanometer 342 at a predetermined angle. The second galvanometer 342 is configured to reflect the laser beam received from the first galvanometer 341 to the workpiece to be processed placed on the workbench 200 at a predetermined angle. Specifically, the first galvanometer 341 is configured to receive the first laser beam and/or the second laser beam reflected by the second reflector 332, and reflect the first laser beam and/or the second laser beam to the second galvanometer 342 at a predetermined angle. Alternatively, the first galvanometer 341 is configured to receive the first laser beam reflected by the second reflector 332 and/or the second laser beam reflected by the second beam combiner 335, and reflect the first laser beam and/or the second laser beam to the second galvanometer 342 at a predetermined angle.

Referring to FIG. 9, in order to facilitate the adjustment of the angle of the first galvanometer 341 and the second galvanometer 342, the galvanometer assembly 340 also includes a first driving part 343 and a second driving part 344. The first driving part 343 is connected to the first galvanometer 341, and is configured to drive the first galvanometer 341 to rotate around the first axis. The second driving part 344 is connected to the second galvanometer 342 and is configured to drive the second galvanometer 342 to rotate around the second axis.

In an embodiment of the present application, the laser processing head 20 further includes a focusing lens. The focusing lens is provided corresponding to the second galvanometer 342. The focusing lens is configured to receive the first laser beam and/or the second laser beam reflected by the second galvanometer 342 and focus it on the workpiece. By providing the focusing lens, the laser beam can be focused.

As shown in FIG. 9, in order to ensure the processing effect of the workpiece, it is necessary to ensure the intensity of the laser acting on the workpiece and prevent dust from covering the galvanometer assembly 340 during use. Therefore, the laser processing head 20 also includes a dust cover 360. The focusing lens is connected to the dust cover 360 and is surrounded by the dust cover 360 to form a dustproof chamber. The first galvanometer 341 and the second galvanometer 342 are provided in the dustproof chamber. It can be understood that, in order to ensure that the first driving part 343 and the second driving part 344 can smoothly drive the first galvanometer 341 and the second galvanometer 342, the dust cover 360 is also provided with a first through hole and a second through hole. The first driving part 343 passes through the first through hole and is connected to the first galvanometer 341, and a second driving part 344 passes through the second through hole and is connected to the second galvanometer 342.

In an embodiment of the present application, the dust cover 360 is provided with a light through hole, and the light through hole is provided corresponding to the reflector assembly 330. The light through hole is configured to allow the reflector assembly 330 to reflect the laser beam to the first galvanometer 341. By providing the light through hole on the dust cover 360, it can be ensured that the laser beam received by the third reflector 334 can be smoothly reflected to the first galvanometer 341.

As shown in FIG. 5, the laser processing head 20 includes a housing 300. The housing 300 is enclosed to form a receiving space. The first laser emitter 310, the second laser emitter 320, the reflector assembly 330 and the galvanometer assembly 340 are all provided in the receiving space. Due to the existence of the housing 300, the user's eyes can be prevented from being stabbed by the emitted laser beam.

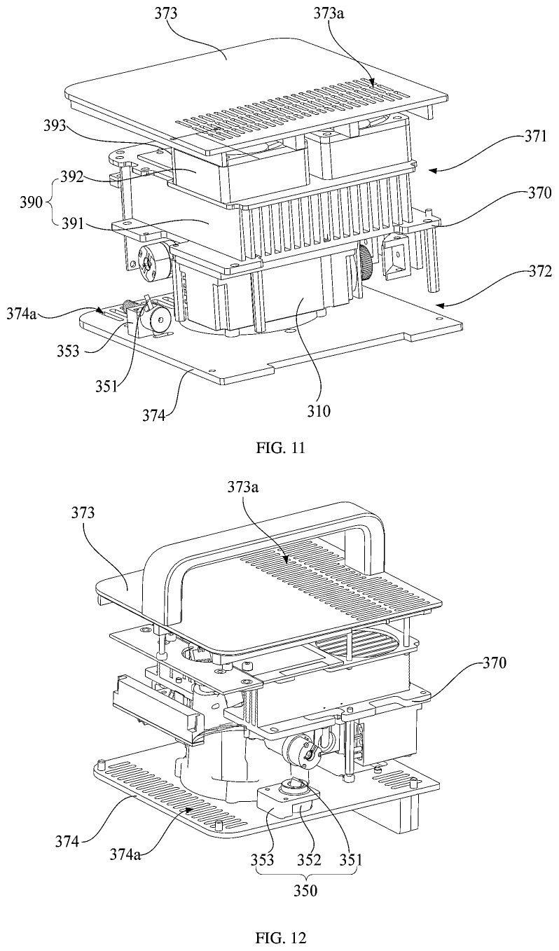

As shown in FIG. 8 and FIG. 11, the laser processing device also includes a first heat dissipation structure 390 and a second heat dissipation structure 180. The first heat dissipation structure 390 is provided in the housing 300. The second heat dissipation structure 180 is provided in the machine base 10 and is configured to dissipate heat in the processing space. By providing the first heat dissipation structure 390, the low-temperature gas from the outside can be sucked into the housing 300 of the laser processing head 20, and the laser can be emitted from the relevant components, namely, heat generated by the first laser emitter 310, the second laser emitter 320, the reflector assembly 330 and the galvanometer assembly 340 and the like is taken away in time to dissipate heat from the components in the housing 300 of the laser processing head 20, thus effectively extending the service life of the laser processing head 20 and the entire device.

Moreover, when the laser processing head 20 processes the workpiece in the processing space, the part of the workpiece processed by the laser will show black and yellow burn marks due to the high temperature. In the embodiment of the present application, since the machine base 10 is provided with the second heat dissipation structure 180, the second heat dissipation structure 180 can cool down the gas in the processing space and reduce the burn marks left on the surface of the workpiece due to processing. The first heat dissipation structure 390 and the second heat dissipation structure 180 make the internal air circulation of the laser processing device better, thereby making the heat dissipation effect better.

In an embodiment of the present application, a heat dissipation channel is formed in the housing 300 and the machine base 10. The heat dissipation channel can receive external air and allow the air to flow through the housing 300 and the machine base 10 and be discharged to the outside. It can be understood that the housing 300 and the machine base 100 are enclosed to form at least a part of the heat dissipation channel. The first heat dissipation structure 390 inhales external air into the interior of the laser processing device through the heat dissipation channel, and the second heat dissipation structure 180 discharges the gas that has absorbed heat inside to the outside through the heat dissipation channel. That is, the inhalation of gas by the first heat dissipation structure 390 and the discharge of gas by the second heat dissipation structure 180 form a flow path of the gas, and since the laser emission-related components are located on the gas flow path of the heat dissipation channel, heat generated by the laser emission-related components can be better taken away in time, so that the device can use gas circulation to discharge the heat generated by each component, which has a better heat dissipation effect on the laser emission-related components and effectively extends the service life of the laser processing head and the entire device.

In an embodiment, as shown in FIG. 11, a ventilation partition 370 is provided in the receiving space of the housing 300. The ventilation partition 370 divides the internal space of the housing 300 into a first space 371 and a second space 372. The second space 372 is closer to the workpiece to be processed than the first space 371. The first heat dissipation structure 390 is provided on one side of the ventilation partition 370 and is located in the first space 371. The first laser emitter 310, the second laser emitter 320, the reflector assembly 330 and the galvanometer assembly 340 are all provided in the second space 372. Since the workpiece is placed on the processing table for processing, providing the first laser emitter 310, the second laser emitter 320, the reflector assembly 330 and the galvanometer assembly 340 in the second space 372 can facilitate better processing of the workpiece.

More specifically, as shown in FIG. 5, the housing 300 includes a first flat plate 373, a second flat plate 374 and a shell 380. The shell 380 is a cylindrical structure with openings at both ends. The first flat plate 373 and the second flat plate 374 are respectively connected to both ends of the shell 380 to close the corresponding openings. The first flat plate 373 and the second flat plate 374 are spaced apart from and parallel to the ventilation partition 370. The first flat plate 373, the ventilation partition 370 and a part of the shell 380 are enclosed to form the first space 371, and the second flat plate 374, the ventilation partition 370 and another part of the shell 380 are enclosed to form the second space 372. In this embodiment, one side of the first flat plate 373 is in contact with the outside, the first heat dissipation structure 390 is provided between the first flat plate 373 and the ventilation partition 370, and the first laser emitter 310, the second laser emitter 320, the reflector assembly 330 and the galvanometer assembly 340 are provided between the ventilation partition 370 and the second flat plate 374. Therefore, the first heat dissipation structure 370 can better absorb gas from the outside, and can ensure that all laser emission-related components that need to be heat dissipated are located on the flow path of the gas. Therefore, the heat dissipation effect on the laser emission-related components is better, and the service life of the laser processing head 20 and the entire equipment can be more effectively extended.

In an embodiment, the first laser emitter 310, the second laser emitter 320, the reflector assembly 330 and the galvanometer assembly 340 are provided side by side on the ventilation partition 370, and are provided in a stacked manner with the first heat dissipation structure 390. On the one hand, the arrangement of the internal parts of the laser processing head 20 is made more compact, reducing the overall area of the laser processing head 20; on the other hand, the stacked arrangement maximizes the contact area between the first heat dissipation structure 390 and the internal components of the laser processing head 20. That is, when the laser processing device is working, the heat generated by the internal components of the laser processing head 20 can be directly transferred to the first heat dissipation structure 390, and the first heat dissipation structure 390 can promptly dissipate heat from the internal components of the laser processing head 20, thereby greatly increasing the heat dissipation speed and extending the service life of the laser processing head 20.

In an embodiment of the present application, the laser processing head 20 is slidingly connected to the machine base 10. Along the moving direction of the laser processing head 20, the projected area of the ventilation partition 370 is smaller than the projected area of the first flat plate 373 and the second flat plate 374. In this embodiment, since the projected area of the ventilation partition 370 is smaller than the projected area of the first flat plate 373 and the second flat plate 374, there is a gap between the ventilation partition 370 and the shell 380, through which the first space 371 can be communicated with the second space 372, so that the gas sucked from the outside can flow from the first space 371 to the second space 372.

The ventilation partition 370 can be provided as an independent structure in the housing 300. The ventilation partition 370 includes a first surface and a second surface opposite to the first surface. The first heat dissipation structure 390 is connected to the first surface, and the first laser emitter 310, the second laser emitter 320, the reflector assembly 330 and the galvanometer assembly 340 are arranged side by side and connected to the second surface. Therefore, the internal components of the laser processing head 20 can directly transfer heat to the first heat dissipation structure 390 through the ventilation partition 370 for heat dissipation, so that the heat dissipation effect is better.

In another embodiment, the ventilation partition 370 can also be used as a part of the first heat dissipation structure 390. For example, the first heat dissipation structure 390 includes heat dissipation fins 391, and the ventilation partition 370 and the heat dissipation fins 391 are integrally formed. The heat dissipation fin 391 is located on one side of the ventilation partition 370, and the first laser emitter 310, the second laser emitter 320, the reflector assembly 330 and the galvanometer assembly 340 are provided on the side of the ventilation partition 370 away from the heat dissipation fin 391.

As shown in FIG. 8, the first flat plate 373 is provided with a first ventilation hole 373a, and the second flat plate 374 is provided with a second ventilation hole 374a. The first heat dissipation structure 390 inhales external air into the housing 300 through the first ventilation hole 373a, and sends the gas in the housing 300 into the processing space through the second ventilation hole 374a. It can be understood that one or multiple first ventilation holes 373a may be provided, and one or multiple second ventilation holes 374a may be provided.

Through this embodiment, the first ventilation hole 373a is provided on the first flat plate 373, so that the first space 371 is connected to the outside. The first heat dissipation structure 390 located in the first space 371 can inhale gas from the outside and allow the gas to flow to the laser emission-related components in the second space 372. The second ventilation hole 374a is provided in the second flat plate 374, so that the second space 372 is connected to the processing space, and the gas sucked from the outside by the first heat dissipation structure 390 can also flow to the processing space.

In an embodiment of the present application, as shown in FIG. 8, the laser processing head 20 is slidingly connected to the machine base 10. Along the moving direction of the laser processing head 20, the projection of the first ventilation hole 373a does not overlap with the projection of the second ventilation hole 374a. Since the first laser emitter 310, the second laser emitter 320, the reflector assembly 330, the galvanometer assembly 340 and other components are arranged flatly in the second space 372, by arranging multiple first ventilation holes 373a and multiple second ventilation holes 374a in a staggered manner, after the gas enters the inside of the second space 372, the flow path of the gas can flow in a direction perpendicular to the moving direction of the laser processing head 20, so that the gas passes through more devices, thereby improving the heat dissipation effect.

In another embodiment of the present application, the first ventilation hole 373a and a third ventilation hole (not shown in the figure) are provided on the first flat plate 373. The first heat dissipation structure 390 inhales the outside air into the housing 300 through the first ventilation hole 373a, and discharges the gas in the housing 300 to the outside through the third ventilation hole. In the embodiment of the present application, by simultaneously providing the first ventilation hole 373a and the third ventilation hole on the first flat plate 373, the first ventilation hole 373a serves as the air inlet and the third ventilation hole serves as the air outlet. Therefore, the first heat dissipation structure 390 can independently complete the heat dissipation of the components in the housing 300 of the laser processing head 20.

Referring to FIG. 11, in an embodiment, the first heat dissipation structure 390 includes a heat dissipation fin 391 and a first fan 392. The heat dissipation fin 391 is connected to the ventilation partition 370. The heat dissipation fin 391 and the internal components of the laser processing head 20 are respectively provided on opposite sides of the ventilation partition 370. The heat dissipation fin 391 is configured to dissipate heat from the internal components of the laser processing head 20. The first fan 392 is located in the first space 371 and is stacked and connected with the heat dissipation fin 391. A first fan 392 is configured to cool down the heat dissipation fin 391. By providing the heat dissipation fin 391 and the first fan 392, the heat dissipation fin 391 can maximize contact with the internal components of the laser processing head 20 for heat dissipation. At the same time, the first fan 392 can blow and cool the heat dissipation fin 391 in time, thereby effectively increasing the heat dissipation speed and improving the heat dissipation effect. In addition, the first fan 392 is stacked on the heat dissipation fin 391, which can make the first heat dissipation structure 390 more compact and further reduce the overall area of the laser processing head 20.

Referring to FIG. 11, in an embodiment of the present application, a baffle 393 is also provided on the heat dissipation fin 391, and the baffle 393 is located on one side of the first fan 392. Taking the orientation shown in FIG. 11 as an example, the baffle 393 is located on the left side of the first fan 392. The baffle 393 is configured to guide the gas entering from the plurality of first ventilation holes 373a to enter between the ventilation partition 370 and the second flat plate 374 in a direction perpendicular to the ventilation partition 370, and to prevent the gas from flowing in a direction parallel to the ventilation partition 370 without passing through laser emission related components. Therefore, by providing the baffle 393, the gas can be better guided between the ventilation partition 370 and the second flat plate 374 to dissipate heat of the laser emission-related components in the second space 372. Therefore, the baffle 393 effectively ensures the integrity of the gas flow path of the heat dissipation channel, and ensures that the heat dissipation channel effectively dissipates heat for the laser emission-related components in the laser processing head 20.

As shown in FIG. 2 and FIG. 5, in an embodiment of the present application, the housing 300 is slidingly connected to the supporting frame 100, the second flat plate 374 is opposite to the surface of the workbench 200, and the second heat dissipation structure 180 is provided in the supporting frame 100.

As shown in FIG. 2, the supporting frame 100 includes a third flat plate 190 and a fourth flat plate 191 opposite to the third flat plate 190, and the second heat dissipation structure 180 is provided between the third flat plate 190 and the fourth flat plate 191. As shown in FIG. 5, the second flat plate 374, the third flat plate 190, the workbench 200 and the enclosure 30 can be enclosed to form a processing space. It can be understood that when the bottom end of the enclosure 30 is in contact with the workbench 200, the enclosure 30, the second flat plate 374, the third flat plate 190 and the workbench 200 are enclosed to form a closed processing space.

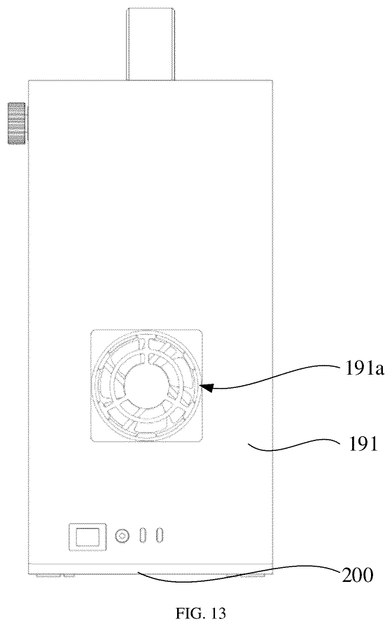

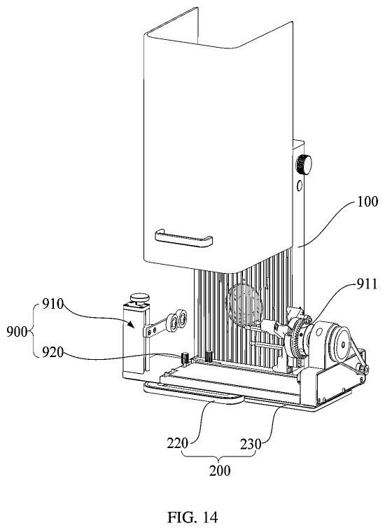

Referring to FIG. 5 and FIG. 13, in an embodiment, the third flat plate 190 is provided with a fourth ventilation hole 190a, the fourth flat plate 191 is provided with an air outlet 191a, and the second heat dissipation structure 180 guides the gas in the processing space to the air outlet 191a through the fourth ventilation hole 190a to discharge the outside. By providing a plurality of fourth ventilation holes 190a and air outlets 191a on the supporting frame 100 to connect the processing space and the outside, the heat and smoke in the processing space can be easily discharged, effectively improving the heat dissipation effect.

The supporting frame 100 can be provided with a plurality of fourth ventilation holes 190a, and the plurality of fourth ventilation holes 190a are configured to connect the processing space and the outside. As shown in FIG. 2 and FIG. 3, the second heat dissipation structure 180 includes a second fan 181, and the second fan 181 is provided on the supporting frame 100 corresponding to a plurality of fourth ventilation holes 190a. By providing the fourth ventilation hole 190a and the air outlet 191a on the supporting frame 100, the work space and the outside are connected to facilitate the removal of heat and smoke in the work space, effectively improving the heat dissipation effect.

It should be noted that the aforementioned heat dissipation channel is formed by the first ventilation hole 373a, the casing 300, the second ventilation hole 374a, the enclosure 30, the fourth ventilation hole 190a and the air outlet 191a. The heat dissipation process of the heat dissipation channel is roughly as follows: the first fan 392 inhales the external low-temperature gas into the first space 371 through the first ventilation hole 373a on the first flat plate 373, and blows the gas toward the heat dissipation fin 391. The gas takes away the heat on the heat dissipation fin 391, and at the same time, the gas enters the second space 372 through the ventilation partition 370 and takes away the heat generated by the laser emission-related components in the second space 372. Then, the gas enters the processing space through the second ventilation hole 374a on the second flat plate 374, and finally the second fan 181 discharges the gas from the air outlet 191a to the outside through the fourth ventilation hole 190a on the supporting frame 100.

Through the first heat dissipation structure 390 and the second heat dissipation structure 180 of the laser processing device of the present application, the device can introduce cold air from the outside and make the gas flow to the space where the laser emission-related components are located. Finally, the gas can be discharged to the outside through the processing space. This cycle increases the air circulation intensity inside the laser processing head 20, resulting in a good heat dissipation effect. This not only realizes the heat dissipation of the laser processing head 20 and the entire device, but also discharges the smoke generated during processing in the processing space, ensuring the smooth progress of the processing process.

In addition, the components of the laser processing head 20 are more compact and more rationally arranged, which facilitates air circulation and improves heat dissipation, thereby effectively extending the service life of the laser processing head 20 and the entire device.

Referring to FIG. 8 and FIG. 11, the laser processing head 20 further includes at least two focusing components 350, and the at least two focusing components 350 are provided on the housing 300 and located in the second space 372. When the light spots projected by at least two focusing components 350 overlap, they are at the same level as the focus point after the laser beam is converged by the focusing lens. Specifically, at least two focusing components 350 are provided inside the housing 300 and on the second flat plate 374, and the focusing components 350 can be light-emitting components.

Before performing laser processing, the user only needs to make the light spots projected by at least two focusing components 350 overlap on the plane of the workpiece to be processed, that is, there is only one light spot on the plane of the workpiece to be processed. At this time, the focusing adjustment of the laser processing device is completed. It can be understood that, in order to prevent the user's eyes from being injured, the light emitted by the focusing component 350 has lower energy than the energy of the laser emitted by the first laser emitter 310 and the second laser emitter 320.

As shown in FIG. 11, in an embodiment of the present application, the focusing component 350 can include a light-emitting part 351 and a fixed part 353. The light-emitting part 351 can be vertically and rotatably connected to the fixed part 353. The fixed part 353 is installed on the second flat plate 374. Since the light-emitting part 351 can rotate vertically relative to the fixed part 353, the angle of the emitted light can be adjusted by rotating the light-emitting part 351. It can be understood that, in order to allow the light spot emitted by the light-emitting part 351 to be projected onto the workpiece to be processed on the workbench 200, a through hole is provided at a position of the second flat plate 374 opposite to the light-emitting part 351, and the light spot emitted by the light-emitting part 351 is projected onto the workpiece through the through hole.

In another embodiment of the present application, as shown in FIG. 12, the focusing component 350 can include a light emitting part 351, a spherical part 352 and a fixed part 353. The spherical part 352 is provided with a cavity, and the light-emitting part 351 is provided in the cavity of the spherical part 352. The fixed part 353 is installed on the second flat plate 374, and the spherical part 352 is embedded in the fixed part 353 and is movable relative to the fixed part 353. Since the spherical part 352 is movable relative to the fixed part 353, the angle of the light emitted from the light-emitting part 351 can be adjusted by rotating the spherical part 352. It can be understood that, in order to allow the light spot emitted by the light-emitting part 351 to be projected onto the workpiece to be processed on the workbench 200, a through hole is provided at a position of the second flat plate 374 opposite to the light-emitting part 351, and the light spot emitted by the light-emitting part 351 is projected onto the workpiece through the through hole. In this embodiment, by assembling the light-emitting part 351 to the movable spherical part 352, a more flexible adjustment of the light emission angle of the focusing component 350 can be achieved.

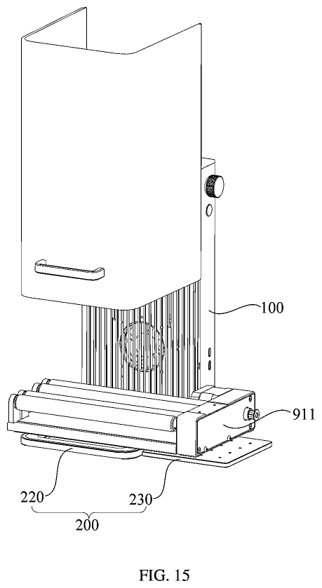

In the present application, the workbench 200 is used to place workpieces. Referring to FIG. 2 and FIG. 14, in some embodiments, the workbench 200 is provided with a connecting through hole 210, and the connecting through hole 210 is connected to the expansion component 900 for fixing or positioning the workpiece.

By providing the connection through hole 210 and the expansion component 900 for fixing or positioning the workpiece on the workbench 200, the workpiece can be reliably fixed on the workbench 200, thereby facilitating the laser processing head 20 to process the workpiece and achieving good processing results. In addition, by using the extension component 900 in conjunction with the connecting through hole 210 on the workbench 200, it is also easy to implement fixed installation and processing of workpieces of various sizes and types, thereby improving the versatility of the laser processing device.

In the embodiment of the present application, the connecting through hole 210 is configured to fix the expansion component 900, to fix or position the workpiece, thereby making the laser processing device suitable for processing different types of workpieces with different functions.

In an embodiment of the present application, as shown in FIG. 2, multiple connecting through holes 210 are provided on the workbench 200, and the multiple connecting through holes 210 are distributed on the workbench 200 in an array. In the embodiment of the present application, by providing a plurality of connection through holes 210 arranged in a rectangular array on the workbench 200, different expansion components 900 can be adapted and fixed, so that the laser processing device can process more different types of workpieces, improving versatility of laser processing device.

In the embodiment of the present application, the expansion component 900 includes, but is not limited to, a positioning component 913 capable of positioning the workpiece, and a rotating accessory 911 capable of clamping and rotating the workpiece, or an expanding accessory 912 capable of carrying and moving the workpiece.

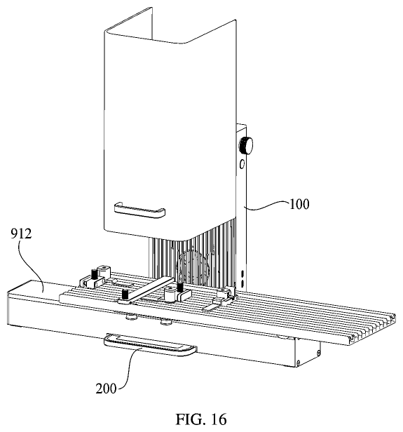

It can be understood that, as shown in FIG. 14 and FIG. 15, when the user needs to process the arc surface of the workpiece, the rotating accessory 911 needs to be used in the work. The rotating accessory 911 is configured to clamp and rotate the workpiece. The rotating accessory 911 can be fixed to the workbench 200 through the connecting through hole 210 at corresponding position on the workbench 200.

Alternatively, as shown in FIG. 16, when the user needs to process a larger workpiece, since the workbench 200 has a limited area and cannot accommodate the larger workpiece. In this case, the amplification accessory 912 needs to be used for processing. The amplification accessory 912 can be fixed on the workbench 200 through the connection through hole 210 at the corresponding position on the workbench 200, thereby positioning or fixing the workpiece in the processing position.

Alternatively, as shown in FIG. 8, when the user processes a batch of the same workpieces, the user can fix the locating piece 913 on the workbench 200 through the connecting through hole 210 at the corresponding position on the workbench 200 to realize the positioning of the workpieces, so that the user does not need to repeatedly adjust the position of the workpiece and the position of the laser focus during the processing process.

In an embodiment of the present application, the expansion component 900 is a fastener 920, and a through hole is provided on the workpiece. The fastener 920 passes through the through hole of the workpiece and is connected to the connection through hole 210 on the workbench 200, so that the workpiece is fixed on the workbench 200.

In an embodiment of the present application, as shown in FIG. 14, the expansion component 900 includes an extension 910 and a fastener 920. One end of the fastener 920 is connected to the extension 910 and the other end is connected to the connecting through hole 210 to detachably connect the extension 910 to the workbench 200. The fastener 920 is configured to relatively fixedly connect the extension 910 to the workbench 200, so that the extension 910 is not easily displaced, thereby ensuring better processing results for the workpiece.

In some embodiments, the fastener 920 includes a nut and a threaded post connected to the nut, and the connecting through hole 210 is a threaded hole. The threaded post passes through the extension 910 and is connected to the threaded hole, and the nut is abutted against the extension 910. By designing the fastener 920 to include a nut and a threaded post, the fastener 920 can relatively fixedly connect the extension 910 to the workbench 200. The fastener 920 has a simple structure, reliable connection, low manufacturing cost and strong versatility.

In other embodiments, the fasteners 920 can also be bolts, pins, etc., as long as the purpose of detachably connecting the extension 910 to the workbench 200 can be achieved.

In an embodiment of the present application, a reference line is provided on the workbench 200, and the reference line is configured to locate the position of the extension 910 on the workbench 200. Specifically, the reference line can be a scale line carved on the upper surface of the workbench 200. Through designing the reference line, the position of the extension 910 on the workbench 200 can be reliably located to ensure the processing effect of the workpiece. At the same time, the extension 910 can be quickly fixed on the workbench 200.

When the user needs to use the extension 910, he can first locate the extension 910 at a preset position on the workbench 200 through the reference line, and then use the fastener 920 to lock and fix the extension 910 relative to the workbench 200. It can be understood that the workbench 200 can be provided with reference lines corresponding to a variety of different extension 910 to adapt to the positioning of different extension 910.

In the embodiment of the present application, the expansion member 910 is used to fix or position the workpiece, and it can be the aforementioned rotating accessory 911, the expanding accessory 912, or the locating piece 913, etc.

Referring to FIG. 14 and FIG. 15, in an embodiment of the present application, the extension 910 is a rotating accessory 911. One end of the fastener 920 is connected to the rotating accessory 911 and the other end is connected to the connecting through hole 210 to detachably connect the rotating accessory 911 to the workbench 200. The workpiece is rotatably connected to the rotating accessory 911.

FIG. 14 and FIG. 15 are schematic diagrams showing the use of the rotating accessory 911 on the workbench 200. The only difference between the two is that the rotating accessory 911 in FIG. 14 and the rotating accessory 911 in FIG. 15 have different structural forms. The rotating accessory 911 in FIG. 14 clamps the workpiece through the rotating clamps at both ends and drives the workpiece to rotate. The rotating accessory 911 in FIG. 15 carries the workpiece through rollers arranged side by side and drives the workpiece to rotate.

It can be understood that the rotating accessory 911 is electrically connected to the laser processing device, and the laser processing device sends an electrical signal to the rotating accessory 911 to control the rotating accessory 911 to drive the workpiece it clamps to rotate, so that the laser processing head 20 can process the arc surface of the workpiece.

In the embodiment of the present application, the rotating accessory 911 can be provided with a connecting hole that is adapted to the fastener 920. The fastener 920 is inserted through the connecting hole and connected to the connecting through hole 210 at the corresponding position on the workbench 200, thereby fixing the rotating accessory 911 on the workbench 200.

When the user needs to process the arc surface of the workpiece, the rotating accessory 911 is connected to the workbench 200 so that the rotating accessory 911 clamps and drives the workpiece to rotate, so that the laser processing head 20 can process the arc surface of the workpiece. In specific implementation, the rotating accessory 911 is used to rotate the position where the arc surface of the workpiece needs to be processed to a position corresponding to the laser processing head 20, so that the laser processing head 20 can process the arc surface of the workpiece.

In an embodiment of the present application, as shown in FIG. 16, the extension 910 is an expanding accessory 912, and the expanding accessory 912 is detachably connected to the workbench 200 through a fastener 920 and a connection through hole 210. The expanding accessory 912 is provided with a conveyor belt, the workpiece is placed on the conveyor belt, and the conveyor belt drives the workpiece to move relative to the workbench 200.

In the embodiment of the present application, the expanding accessory 912 can be provided with a connection hole that matches the fastener 920. The fastener 920 is inserted through the connection hole and connected to the connecting through hole 210 at the corresponding position on the workbench 200 to fix the expanding accessory 912 on the workbench 200.

It can be understood that the expanding accessory 912 is electrically connected to the laser processing device, and the laser processing device sends an electrical signal to the expanding accessory 912 to control the movement of the conveyor belt of the expanding accessory 912, so that the workpiece on the conveyor belt can moves directly under the laser processing head 20, and the laser processing head 20 can process different areas of the workpiece or process multiple workpieces in sequence.

When the user needs to process a workpiece with a larger area, the expanding accessory 912 is connected to the workbench 200, so that the expanding accessory 912 can drive the workpiece to move, and the area to be processed of the workpiece sequentially moves to directly below the laser processing head 20, thereby achieving the purpose of the laser processing head 20 to process the workpiece with a larger area.

Alternatively, when multiple workpieces need to be processed continuously, multiple workpieces can be placed on the expanding accessory 912, so that the expanding accessory 912 can drive multiple workpieces to move, and each workpiece moves to directly below the laser processing head 20 in turn. Therefore, the laser processing head 20 can continuously process multiple workpieces.

Specifically, the expanding accessory 912 is provided with a conveyor belt, which is used to carry and convey the workpieces to the processing range of the laser processing head 20, so that the laser processing head 20 can continuously process large-format workpieces or multiple workpieces.

In an embodiment of the present application, as shown in FIG. 8, the expansion 910 is a locating piece 913. One end of the fastener 920 is connected to the locating piece 913, and the other end is connected to the connecting through hole 210, so that the locating piece 913 can be detachably connected to the workbench 200.

It can be understood that the locating piece 913 can be provided with a connection hole adapted to the fastener 920, and the fastener 920 is inserted through the connection hole and connected to the connection through hole 210 at the corresponding position on the workbench 200, so as to fix the locating piece 913 on the workbench 200.

The locating piece 913 is configured to locate the workpiece at a preset position on the workbench 200. As shown in FIG. 8, the locating piece 913 can be an L-shaped protrusion provided on the workbench 200. When the workpiece to be processed is the same, the workpiece to be processed can be positioned through the locating piece 913, so that the user does not need to repeatedly adjust the position of the workpiece and the focus position of the laser multiple times.

Specifically, according to the bottom area of the workpiece, the user can connect the locating piece 913 with the connection through hole 210 at the corresponding position on the workbench 200 through the fastener 920, thereby fixing the locating piece 913 on the workbench 200 to better position the workpiece.

Alternatively, when the laser processing device needs to process multiple workpieces at the same time, multiple workpieces need to be positioned. At this time, multiple positioning members 913 can be provided on the workbench 200, and each locating piece 913 is fixed on the workbench 200 through a fastener 920, thereby positioning multiple workpieces respectively.

In an embodiment of the present application, the expansion component 900 can only include a fastener 920, one end of the fastener 920 is connected to the connection through hole 210, and the other end is used to connect with the workpiece. Specifically, the workpiece is provided with a connection hole that matches the fastener 920. The workpiece can be fixed at a predetermined position on the workbench 200 by using the fastener 920 to penetrate the connecting through hole 210 at the corresponding position on the workbench 200 and the connection hole on the workpiece, thereby facilitating the laser processing head 20 to process the workpiece.

In an embodiment of the present application, as shown in FIG. 2, the workbench 200 includes a base 220 and a bottom plate 230, and the bottom plate 230 is detachably assembled on the base 220. Specifically, the base 220 is provided with an assembly part, and the bottom plate 230 is installed in the assembly part. The assembly part can be an opening that passes through the base 220. An abutting edge protruding inward is provided on the circumference of the opening, and the bottom plate 230 is assembled to the opening of the base 220 through the abutting edge.

By designing the workbench 200 to include the base 220 and the bottom plate 230, when the workpiece to be processed is relatively large and cannot be placed in the processing space between the workbench 200 and the laser processing head 20, the laser processing device can be directly placed on the workpiece to be processed, and the bottom plate 230 is removed from the base 220. At this time, the assembly part can be light-transmissive, so that the laser can directly pass through the assembly part of the workbench 200 and act on the workpiece. This increases the applicability of the laser processing device of this embodiment, making the device suitable for processing larger workpieces.

It can be understood that, in order to facilitate the removal of the bottom plate 230 from the base 220, the base 220 is also provided with a disassembly part 221. As shown in FIG. 2, the disassembly part 221 can be a groove provided on the base 220, and the groove can be in a strip shape, a rectangular shape, a circular shape, etc., which is not limited in the embodiment of the present application. By providing the disassembly part 221 on the base 220, it is convenient for the user to remove the base plate 230 from the base 220.

Please continue to refer to FIG. 2, the surface of the base 220 facing the laser processing head 20 is flush with the surface of the bottom plate 230 facing the laser processing head 20. By designing the upper surfaces of the base 220 and the bottom plate 230 to be flush surfaces, it is easy to connect and position the workpieces and various types of extensions 910, and the processing effect of the workpieces is better.

As shown in FIG. 14 and FIG. 15, when the length of the extension 910 is relatively long, in order to stably fix the extension 910 on the workbench 200, the bottom plate 230 can be removed from the base 220 and placed side by side on the outside of the base 220. Since the upper surfaces of the base 220 and the bottom plate 230 are designed to be flush surfaces, the extension 910 can be placed stably on the workbench 200. The fastener 920 fixes the extension 910 by connecting the connection through hole 210 on the base 220 and the connection through hole 210 on the bottom plate 230 to prevent the extension 910 from being stably fixed on the workbench 200 due to being too long, thereby allowing the workpiece to be stably processed.

It can be understood that the aforementioned connection through hole 210 can be provided on the base 220 or the bottom plate 230. Alternatively, the base 220 and the bottom plate 230 can both be provided with connection through holes 210.

It should be noted that since the base 220 and the machine body are usually integrally formed, connecting the workpiece or the extension 910 through the connection through hole 210 on the base 220 can prevent the workpiece or the extension 910 from being easily displaced, thereby ensuring better processing results for the workpiece.

Of course, during actual operation, for example, when the fastener 920 or the locating piece 913 is used to position and fix the workpiece, the workpiece or the locating piece 913 can be connected through the connection through hole 210 on the base 220 and the connection through hole 210 on the bottom plate 230.

For the specific implementation of each of the above operations, please refer to the previous embodiments and will not be described again here. It can be understood that, for those skilled in the art, equivalent substitutions or changes can be made based on the technical solutions and inventive concepts of the present application, and all such changes or substitutions should fall within the scope of the present application.

What is claimed is:

1. A laser processing device, comprising:
a machine base, configured to bear a workpiece to be processed;
a laser processing head connected to the machine base, wherein the laser processing head is configured to process the workpiece to be processed; and
an enclosure slidably connected to the machine base, wherein the enclosure is configured to filter a laser beam reflected when the laser processing head processes the workpiece to be processed.

2. The laser processing device of claim 1, wherein the enclosure is slidingly connected to the machine base, and the enclosure is movable relative to the laser processing head.

3. The laser processing device of claim 2, wherein a projection of the laser processing head at least partially coincides with a projection of the enclosure along a direction perpendicular to a sliding movement of the enclosure.

4. The laser processing device of claim 1, wherein the machine base comprises a supporting frame and a workbench connected to the supporting frame, and the workbench is configured to bear the workpiece to be processed;
the laser processing head is connected to the supporting frame, and the laser processing head is opposite to the workbench; the enclosure is slidingly connected to the supporting frame, and when the enclosure is abutted against the workbench, the laser processing head, the workbench, the supporting frame and the enclosure are enclosed to form a processing space.

5. The laser processing device of claim 4, further comprising:
a hover assembly provided between the enclosure and the supporting frame,
wherein the hover assembly is configured to keep the enclosure in a hovering state to open the processing space.

6. The laser processing device of claim 5, wherein the hover assembly comprises an elastic member, one end of the elastic member is connected to the supporting frame, the other end of the elastic member is connected to the enclosure, and the elastic member is configured to enable the enclosure to have a tendency to move in a direction away from the workbench.

7. The laser processing device of claim 6, wherein the hover assembly further comprises a winding post, the winding post is provided on an end of the supporting frame away from the workbench, and the elastic member is wound around on the winding post.

8. The laser processing device of claim 6, further comprising:
a locking assembly,
wherein the locking assembly is provided between the workbench and the enclosure or is provided between the supporting frame and the enclosure, and the locking assembly is configured to abut the enclosure against the workbench to close the processing space.

9. The laser processing device of claim 8, wherein the locking assembly comprises a first magnetic block and a second magnetic block, the first magnetic block is provided on the workbench or the supporting frame, the second magnetic block is provided on the enclosure and faces the first magnetic block, and adsorption force generated by the first magnetic block and the second magnetic block is configured to abut the enclosure against the workbench.

10. The laser processing device of claim 9, wherein when the processing space is closed, the adsorption force generated by the first magnetic block and the second magnetic block is greater than an elastic force exerted by the elastic member on the enclosure.

11. The laser processing device of claim 4, further comprising:
a limiting assembly provided between the supporting frame and the enclosure,
wherein the limiting assembly is configured to limit a sliding displacement range of the enclosure relative to the supporting frame.

12. The laser processing device of claim 11, wherein the limiting assembly comprises a first limiting block and a second limiting block, the first limiting block is provided on the supporting frame, the second limiting block is provided on the enclosure, and the first limiting block is configured to abut against the second limiting block to limit the sliding displacement range of the enclosure relative to the supporting frame.

13. The laser processing device of claim 4, wherein the laser processing head is slidingly connected to the supporting frame, a driving assembly connected to the laser processing head is provided inside the supporting frame, and the driving assembly is configured to drive the laser processing head to slide relative to the supporting frame.

14. The laser processing device of claim 13, wherein the supporting frame comprises a slider, a connecting groove and a fixed plate, the connecting groove is a strip-shaped through groove provided on a surface of the supporting frame, the slider is provided inside the supporting frame, one end of the slider is connected to the driving assembly and the other end is connected to the fixed plate through the connecting groove, and the fixed plate is also connected to the laser processing head.

15. The laser processing device of claim 13, further comprising:
a control assembly electrically connected to the driving assembly,
wherein the control assembly is configured to send an electrical signal to the driving assembly to cause the driving assembly to drive the laser processing head to move.

16. The laser processing device of claim 15, wherein the control assembly comprises a knob, a first circuit board and a second circuit board provided on the machine base, the knob is connected to the first circuit board, the first circuit board is electrically connected to the second circuit board, and the second circuit board is electrically connected to the driving assembly; and
the knob is configured to be rotated in different directions to trigger the first circuit board to send different electrical signals, and the first circuit board is configured to send the electrical signals to the driving assembly via the second circuit board.

17. The laser processing device of claim 4, wherein the enclosure is provided with a connecting block, and the supporting frame is provided with a sliding rod inside; the connecting block is provided with a sliding hole slidingly matched with the sliding rod, and the connecting block is configured to slide up and down relative to the supporting frame through the sliding rod passing through the sliding hole.

18. The laser processing device of claim 4, wherein the supporting frame is provided with a chute, the enclosure is provided with a sliding bar, and the sliding bar is slidingly provided in the chute.

19. The laser processing device of claim 18, wherein the enclosure is provided with a handle, and the sliding bars on the enclosure move along the chute on the supporting frame.

20. The laser processing device of claim 14, wherein the driving assembly comprises a driving piece and a screw rod, and the driving piece and the screw rod are provided inside the supporting frame; and a length direction of the screw rod is parallel to a length direction of the connecting groove, the slider is sleeved outside the screw rod and is threaded with the screw rod, and one end of the screw rod is connected to a driving shaft of the driving piece.
